(19) United States
(12) Patent Application Publication
(10) Pub. No.: US 2010/0057678 A1
(43) Pub. Date: Mar. 4, 2010

(54) IMPORT/EXPORT MODELING SYSTEM

(76) Inventors: Gene Fein, Malibu, CA (US); Edward Merritt, Lenox, MA (US)

Correspondence Address: FOLEY & LARDNER LLP, 150 EAST GILMAN STREET, P.O. BOX 1497, MADISON, WI, 53701-1497, US

(21) Appl. No.: 12/200,269

(22) Filed: Aug. 28, 2008

(51) Int. Cl. G06F 17/30

(52) U.S. Cl. 707/3; 707/E17.135

(57) ABSTRACT

A device is provided for use in modeling an import/export system. The device includes a communication interface, a processor, and a computer-readable medium including computer-readable instructions. Upon execution by the processor, the computer-readable instructions causes the device to receive a query from a second device, determine a response to the query using import/export data received from a plurality of information sources, and send the determined response to the second device.

### BACKGROUND

Crates, packages, containers, and freight vessels are a major part of the global economic infrastructure. These objects may be tracked using a variety of sensing and communication technologies. For example, objects can be tracked using a global positioning system (GPS), using radar, video, color matching, ultra-violet, optical, and infrared signals, using radio frequency identifier (RFID) systems and transponders, etc. As an example, a ship can be tracked using a transponder system and/or a GPS tracking technology. As another example, a cargo object may be tracked using an RFID system. Additionally, satellites can track objects in real time from space.

Cargo generally is logged before it departs from a port. A vessel traveling between ports has an itinerary that is published prior to departure. Freight or cargo vessels must gain formal permitted entry that requires physical or digital documentation prior to a vessel arriving at a port. Once a cargo vessel arrives at a port the vessel's manifesto is examined, and the cargo is identified and recorded. In many cases inspections take place and are documented. As a result, large amounts of data are generated that describe an import/export system locally, regionally, or globally.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 depicts a block diagram of an import/export modeling system in accordance with an illustrative embodiment.

FIG. 2 depicts a block diagram of a user computing device of the import/export modeling system of FIG. 1 in accordance with an illustrative embodiment.

FIG. 3 depicts a block diagram of a middleware system of the import/export modeling system of FIG. 1 in accordance with an illustrative embodiment.

FIG. 4 depicts a block diagram of a cloud computing system of the import/export modeling system of FIG. 1 in accordance with an illustrative embodiment.

FIG. 5 depicts a flow diagram illustrating operations performed by the cloud computing system of FIG. 4 in accordance with an Illustrative embodiment.

FIG. 6 depicts a flow diagram illustrating operations performed by the user computing device of FIG. 2 in accordance with an Illustrative embodiment.

FIG. 7 depicts a flow diagram illustrating operations performed by the middleware system of FIG. 3 in accordance with an Illustrative embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

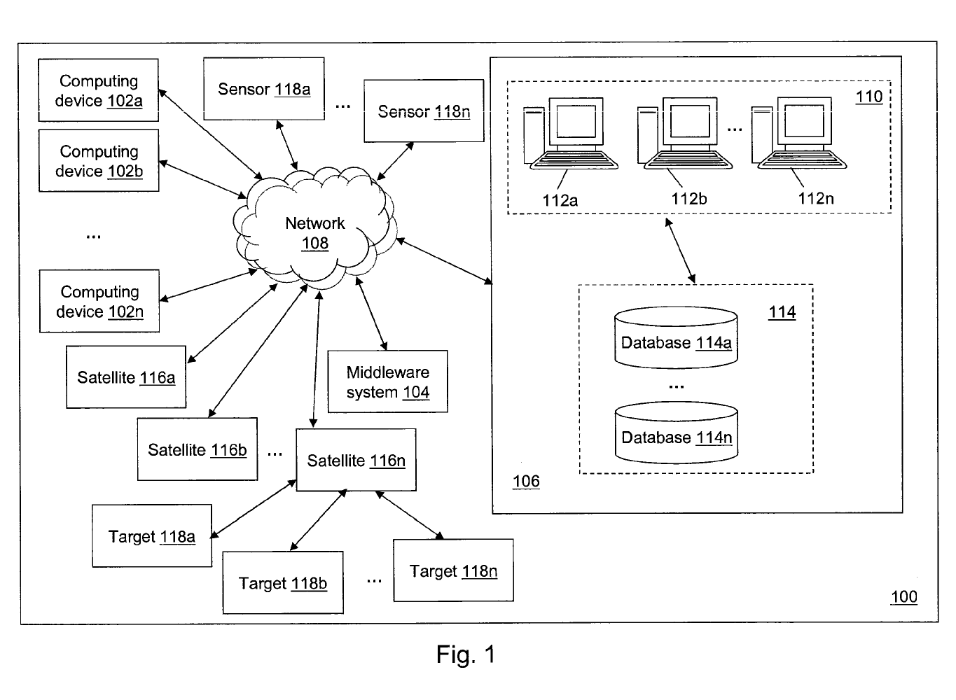

Illustrative systems, methods, devices, etc. are described for creating a global import/export modeling system using a variety of sensing, communication, modeling, and database management technologies. With reference to FIG. 1, a block diagram of an import/export modeling system 100 is shown in accordance with an illustrative embodiment. Import/export modeling system 100 can include one or more user computing devices 102a, 102b, . . . , 102n, a middleware system 104, a cloud computing system 106, one or more satellites 116a, 116b, . . . , 116n, and one or more sensors 120a, . . . , 120n. The one or more user computing devices 102a, 102b, . . . , 102n may be a computer of any form factor including a laptop, a desktop, a server, an integrated messaging device, a personal digital assistant, a cellular telephone, an iPod™, etc. The one or more user computing devices 102a, 102b, . . . , 102n may be associated with the same and/or different users. Each of the one or more satellites 116a, 116b, . . . , 116n can track one or more targets 118a, 118b, . . . , 118n using one or more sensor mounted on the satellite. Additionally, or in the alternative, a sensor(s) of the one or more sensors 120a, . . . , 120n may detect and track the one or more targets 118a, 118b, . . . , 118n. The one or more targets 118a, 118b, . . . , 118n may be tracked intermittently, for example, when a ship enters a port, the ship's content may be identified and the current location provided to import/export modeling system 100. The types of cargo, the amounts, the date, the weight, the numbers of vessels, etc. may be tracked and associated with a port, a country, a region, etc. The data may be stored to middleware system 104 and/or cloud computing system 106.

The devices associated with the one or more user computing devices 102a, 102b, . . . , 102n, middleware system 104, cloud computing system 106, the one or more satellites 116a, 116b, . . . , 116n, and the one or more sensors 120a, . . . , 120n may communicate using a network 108. Network 108 may include one or more type of network including a cellular network, a peer-to-peer network, the Internet, a local area network, a wide area network, a Wi-Fi network, a Bluetooth™ network, etc.

Cloud computing system 106 can include one or more servers 110 and one or more databases 114. A cloud computing system refers to one or more computational resources accessible over a network to provide users on-demand computing services. The one or more servers 110 can include one or more computing devices 112a, 112b, . . . , 112n which may be computers of any form factor. The one or more databases 114 can include a first database 114a, . . . , and an nth database 114n. The one or more databases 114 can be housed on one or more of the one or more servers 110 or may be housed on separate computing devices accessible by the one or more servers 110 directly through wired or wireless connection or through network 108. The one or more databases 114 may be organized into tiers and may be developed using a variety of database technologies without limitation. The components of cloud computing system 106 may be implemented in a single computing device or a plurality of computing devices in a single location, in a single facility, and/or may be remote from one another.

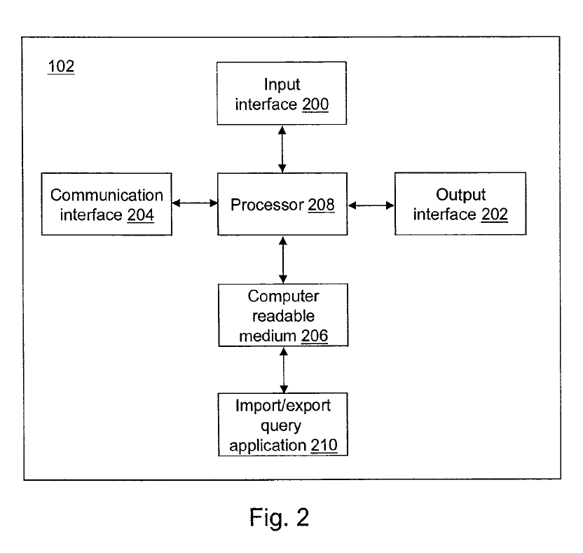

With reference to FIG. 2, a block diagram of a user computing device 102 of import/export modeling system 100 is shown in accordance with an illustrative embodiment. User computing device 102 can include an input interface 200, an output interface 202, a communication interface 204, a computer-readable medium 206, a processor 208, and an import/export query application 210. Different and additional components may be incorporated into user computing device 102 without limitation. Import/export query application 210 provides a graphical user interface with user selectable and controllable functionality. Import/export query application 210 may include a browser application or other user interface based application that interacts with middleware system 104 to allow a user to submit a request for information related to import/export modeling system 100.

Input interface 200 provides an interface for receiving information from the user for entry into user computing device 102 as known to those skilled in the art. Input interface 200 may interface with various input technologies including, but not limited to, a keyboard, a pen and touch screen, a mouse, a track ball, a touch screen, a keypad, one or more buttons, etc. to allow the user to enter information into user computing device 102 or to make selections presented in a user interface displayed using a display under control of import/export query application 210. Input interface 104 may provide both an input and an output interface. For example, a touch screen both allows user input and presents output to the user. User computing device 102 may have one or more input interfaces that use the same or a different interface technology.

Output interface 202 provides an interface for outputting information for review by a user of user computing device 102. For example, output interface 202 may include an interface to a display, a printer, a speaker, etc. The display may be any of a variety of displays including, but not limited to, a thin film transistor display, a light emitting diode display, a liquid crystal display, etc. The printer may be any of a variety of printers including, but not limited to, an ink jet printer, a laser printer, etc. User computing device 102 may have one or more output interfaces that use the same or a different interface technology.

Communication interface 204 provides an interface for receiving and transmitting data between devices using various protocols, transmission technologies, and media. The communication interface may support communication using various transmission media that may be wired or wireless. User computing device 102 may have one or more communication interfaces that use the same or different protocols, transmission technologies, and media.

Computer-readable medium 206 is an electronic holding place or storage for information so that the information can be accessed by processor 208. Computer-readable medium 206 can include, but is not limited to, any type of random access memory (RAM), any type of read only memory (ROM), any type of flash memory, etc. such as magnetic storage devices (e.g., hard disk, floppy disk, magnetic strips, . . . ), optical disks (e.g., compact disk (CD), digital versatile disk (DVD), . . . ), smart cards, flash memory devices, etc. User computing device 102 may have one or more computer-readable media that use the same or a different memory media technology. User computing device 102 also may have one or more drives that support the loading of a memory media such as a CD, a DVD, a flash memory card, etc.

Processor 208 executes instructions as known to those skilled in the art. The instructions may be carried out by a special purpose computer, logic circuits, or hardware circuits. Thus, processor 208 may be implemented in hardware, firmware, software, or any combination of these methods. The term “execution” is the process of running an application or the carrying out of the operation called for by an instruction. The instructions may be written using one or more programming language, scripting language, assembly language, etc. Processor 208 executes an instruction, meaning that it performs the operations called for by that instruction. Processor 208 operably couples with input interface 200, with output interface 202, with communication interface 204, with computer-readable medium 206, and with import/export query application 210 to receive, to send, and to process information. Processor 208 may retrieve a set of instructions from a permanent memory device and copy the instructions in an executable form to a temporary memory device that is generally some form of RAM. User computing device 102 may include a plurality of processors that use the same or a different processing technology.

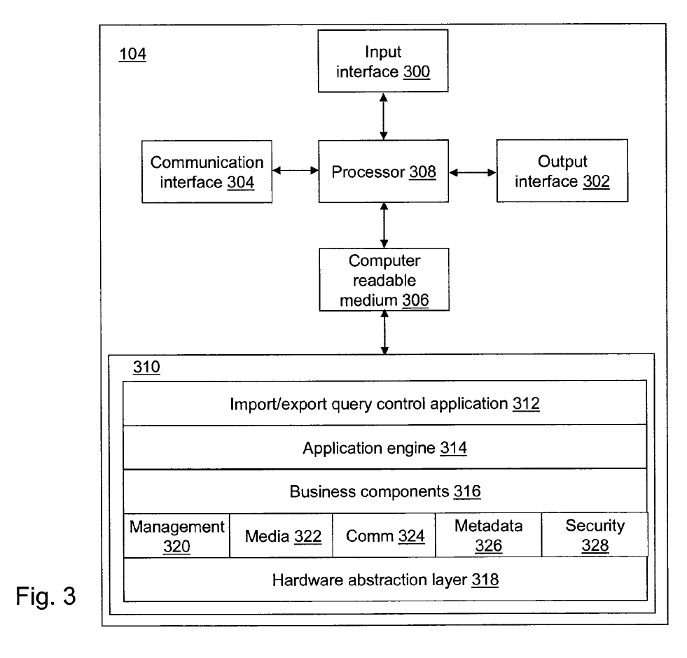

With reference to FIG. 3, a block diagram of middleware system 104 of import/export modeling system 100 is shown in accordance with an illustrative embodiment. Middleware system 104 can include an input interface 300, an output interface 302, a communication interface 304, a computer-readable medium 306, a processor 308, and an import/export modeling architecture 310. Different and additional components may be incorporated into middleware system 104 without limitation. For example, middleware system 104 may include a database that is directly accessible by middleware system 104 or accessible by middleware system 104 using a network such as network 108. Middleware system 104 may further include a cache for temporarily storing information communicated to middleware system 104. Input interface 300 provides similar functionality to input interface 200. Output interface 302 provides similar functionality to output interface 202. Communication interface 304 provides similar functionality to communication interface 204. Computer-readable medium 306 provides similar functionality to computer-readable medium 206. Processor 308 provides similar functionality to processor 208.

Import/export modeling architecture 310 can include an import/export query control application 312, an application engine 314, business components 316, and a hardware abstraction layer 318. Import/export query control application 312 includes the operations associated with interfacing between cloud computing system 106 and user computing device 102 to maintain and organize import/export data and to process a request related to import/export modeling system 100. Import/export modeling architecture 310 inludes functionality to support tracking of a container, a sub-container, vessel, mapping with tracking information, current destination with video reference if available, projected shipping route, revisions of projected shipping route as based upon actual changes to shipping route, list of tracking opportunities in the future of the shipping route, alert as to changes in shipping route progress, alerts based upon custom parameters, such as 1 hour from delivery, delivery, problem with delivery or changed route, etc.

Import/export modeling architecture 310 may utilize load balancing servers, content servers, database servers, application servers, and registration servers. The application and registration servers facilitate the registration process for a user as well as the download of import/export query application 210 and application updates. Middleware system 104 is configured to download the correct software application for the one or more user computing devices 102a, 102b, . . . , 102n based upon registration information received from the user. During the registration process the user may fill in certain fields that assist in the identification of the user's contacts. User related data is received from the one or more user computing devices 102a, 102b, . . . , 102n and formatted using the application and database servers. The load balancing servers sort user queries. Middleware system 104 sends user location data points to cloud computing system 106.

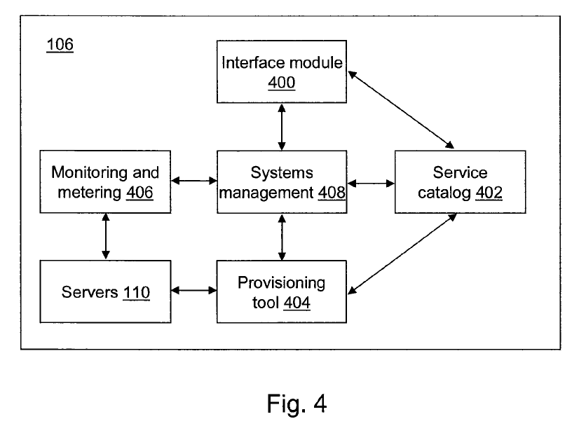

With reference to FIG. 4, a block diagram of modules associated with cloud computing system 106 of import/export modeling system 100 is shown in accordance with an illustrative embodiment. Cloud computing system 106 can include an interface module 400, a service catalog 402, a provisioning tool 404, a monitoring and metering module 406, a system management module 408, and the one or more servers 110. Different and additional components may be incorporated into cloud computing system 106 without limitation. For example, cloud computing system 106 may further include the one or more databases 114. Middleware system 104 interacts with interface module 400 to request services. Service catalog 402 provides a list of services that middleware system 104 can request. Provisioning tool 404 allocates computational resources from the one or more servers 110 to deliver the requested service and may deploy the required images for execution at the one or more servers 110. Monitoring and metering module 406 tracks the usage of the one or more servers 110 so the resources used can be attributed to a certain user possibly for billing purposes. System management module 408 manages the one or more servers 110. The one or more servers 110 can be interconnected as if in a grid running in parallel.

Interface module 400 may be configured to allow selection of a service from service catalog 402. A request associated with a selected service may be sent to system management module 408. System management module 408 identifies an available resource(s) such as one or more of servers 110 and/or one or more of databases 114. System management module 408 calls provisioning tool 404 to allocate the identified resource(s). Provisioning tool 404 may deploy a requested stack or web application as well.

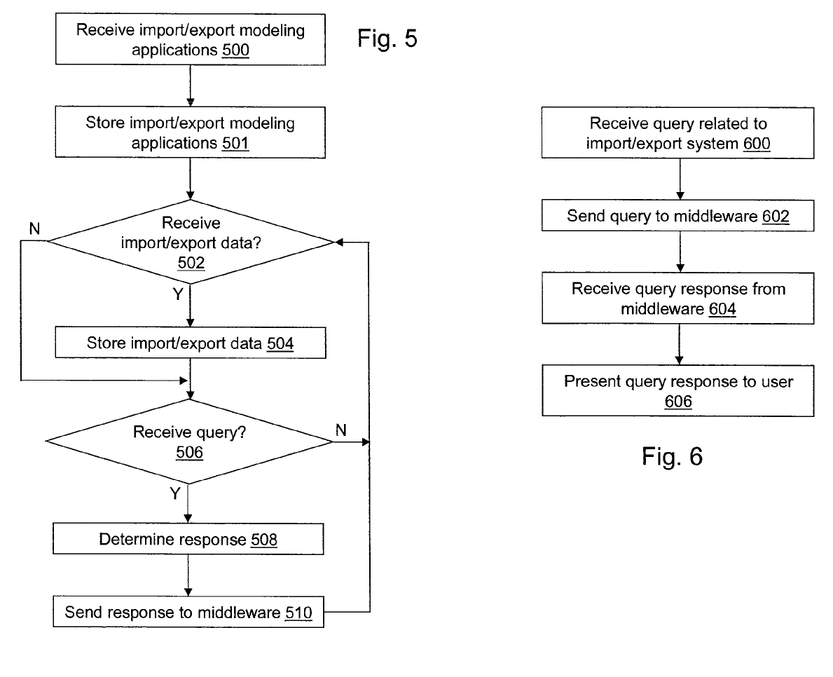

With reference to FIG. 5, illustrative operations performed by cloud computing system 106 are described. Additional, fewer, or different operations may be performed, depending on the embodiment. The order of presentation of the operations of FIG. 5 is not intended to be limiting. In an operation 500, one or more import/export modeling applications are received. For example, an import/export modeling application includes instructions to determine trends associated with an import/export system. The import/export modeling application may be in a text format, an object code format, or an executable format. The received one or more import/export modeling applications are stored to cloud computing system 106 in an operation 501. If import/export data is received in an operation 502, the received import/export data is stored to cloud computing system 106 in an operation 504. For example, the types of cargo and amount of each type shipped on a first ship arriving at a first port on June 1 may be received. If import/export data is not received in an operation 502, processing continues at an operation 506. If a query is not received in operation 506, processing continues at operation 502.

If a query is received in operation 506, the query is processed using the received one or more import/export modeling applications to determine information for responding to the query. In an operation 510, the determined information is sent to middleware system 104. Processing continues at operation 502 to continually receive and store import/export data and to respond to queries from middleware system 104.

As an example, the received one or more import/export modeling applications may utilize import/export data that is already being collected in the shipping industry. The received one or more import/export modeling applications organize and model the data to identify trends in the import/export industry to enable close to real time modeling and delivery of responses to queries to numerous end users. As this data becomes culled and modeled, certain trends may be tracked. For example, a country may have shipped 5,000 tons of widgets on a certain date from five ports using 22 freighters. The data can be compared with corn shipments received on the same date/today/on the same date last year, etc. to model widget shipments to and from the countries ports, or any ports, all over the world. Total numbers of containers for all ports or for certain ports based upon sortable data parameters can also be obtained.

Cloud computing system 106 may connect disparate databases created in different languages using different programs and methods into a single data resource. Cloud computing system 106 may manage and organize the data using a variety of software application programming interfaces, “brute force” techniques, screen scraping, and a variety of other techniques such as conversion of data through hearing impaired software translation. After this conversion, the data may be converted to a primary database application. Once the data is collected and compiled efficiently, it can be sorted via a variety of different data fields, such as contents of shipments, size of shipments, shipments grouped by a variety of aggregate definitions, name of vessel, name of departing and arriving ports, tariffs, port authorization paperwork, customs paperwork, time, date, etc.

Database keys via database programming can be enabled to perform actions using comparison points for data and sorting methods. Such keys can include groupings of data based upon port or country of origin combined with date sensitive sorts relating to specific kinds of cargo enabling both instant and archived views of data. This enables cargo to be modeled in the aggregate, or with the specific ability to focus database queries to locate a specific piece of cargo shipped to a specific person, within a time range, sent to or from specific locations.

Ancillary research data that may impact the import/export industry may also be collected. The ancillary research data may include real time and archived data such as shipbuilding data, weather data, industry specific data (such as electronics or metals, etc), currency exchange data, consumer trends, individual country socioeconomic data, political data, cost of fuel data, cost of tariffs data, cost of insurance data, environmental data, other associated shipping costs data, forecasted market trends, etc.

By creating a unified database between the research data and the shipping data, advanced keys can be created integrating system logic to facilitate a predictive analysis process to model future shipping and port activities. Because the data flows into import/export modeling system 100 continuously in near real-time, the resulting modeling is subject to change based upon new data and database keys may also be programmed to change based upon certain data conditions that may occur.

With reference to FIG. 6, illustrative operations performed by user computing device 102 are described. Additional, fewer, or different operations may be performed, depending on the embodiment. The order of presentation of the operations of FIG. 6 is not intended to be limiting. In an operation 600, a query is received. In an operation 602, the query is sent to middleware system 104. In an operation 604, a query response is received from middleware system 104. In an operation 606, a response to the query is presented at user computing device 102. For example, a map may be displayed to the user indicating the location of a shipment using output interface 202, statistics related to the import/export system modeled may be presented using output interface 202, etc.

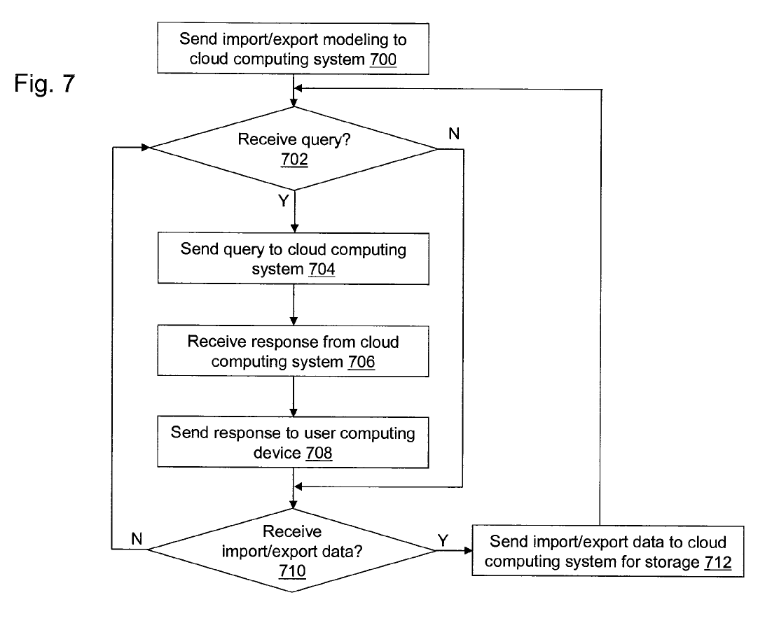

With reference to FIG. 7, illustrative operations performed by middleware system 104 are described. Additional, fewer, or different operations may be performed, depending on the embodiment. The order of presentation of the operations of FIG. 7 is not intended to be limiting. Middleware system 104 defines the parameters for returning readable data to computing device 102 using application programming interfaces, for example, associated with operating system compatibility, display capability, media player capability, etc. In an operation 700, the one or more import/export modeling applications are sent to cloud computing system 106. If a query is not received in an operation 702, processing continues in an operation 710. If a query is received from user computing device 102 in operation 702, processing continues in an operation 704. In operation 704, the query is sent to interface module 400 of cloud computing system 106. In an operation 706, a response is received from interface module 400 of cloud computing system 106. In an operation 708, the response is sent to user computing device 102.

If import/export data is not received in operation 710, processing continues in operation 702 to continually receive and store import/export data and to respond to queries. If import/export data is received in operation 710, processing continues in an operation 712. In operation 712, the received import/export data is sent to interface module 400 of cloud computing system 106 to store the import/export data. Processing continues in operation 702.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits, Field Programmable Gate Arrays, digital signal processors, or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position arid/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A device comprising:
a communication interface configured to receive a query from a second device;
a processor; and
a computer-readable medium including computer-readable instructions that, upon execution by the processor, cause the device to
determine a response to the query using import/export data received from a plurality of information sources; and
send the determined response to the second device.

2. The device of claim 1, wherein the communication interface is further configured to receive an import/export modeling application from the second device.

3. The device of claim 2, wherein the processor executes the received import/export modeling application to determine the response to the query.

4. A computer-readable medium including computer-readable instructions that, upon execution by a processor, cause a device to:
receive a query from a second device;
determine a response to the query using import/export data received from a plurality of information sources; and
send the determined response to the second device.

5. A method comprising:
receiving a query from a second device at a first device;
determining a response to the query using import/export data received from a plurality of information sources; and
sending the determined response to the second device from the first device.
